(19) United States
(12) Patent Application Publication
(10) Pub. No.: US 2010/0070889 A1
(43) Pub. Date: Mar. 18, 2010

(54) Methods for Bundling Disparate Sets of Web Resources to Unique String Identifiers

(76) Inventors: Adam Weisbart, San Francisco, CA (US); Trevor Griffiths, Los Gatos, CA (US)

Correspondence Address: WILSON, SONSINI, GOODRICH & ROSATI, 650 PAGE MILL ROAD, PALO ALTO, CA, 94304-1050, US

(21) Appl. No.: 12/556,539

(22) Filed: Sep. 9, 2009

Related U.S. Application Data
(63) Continuation-in-part of application No. 12/060,087, filed on Mar. 31, 2008.
(60) Provisional application No. 61/095,600, filed on Sep. 9, 2008.

(51) Int. Cl. G06F 15/16; G06F 3/048

(52) U.S. Cl. 715/760; 709/206

(57) ABSTRACT

Methods for bundling disparate sets of web resources to unique string identifiers. The application may contain links to various interactive functions contextual to the web page displayed, and may provide functionality to the user because the various sessions do not open as pop-ups that block the viewing of the web page, or as a new tab or browser window, or as links directing the user to separate web pages; rather the sessions open as semi-transparent windows within the page that do not block the view of the underlying web page and are published seamlessly without having to reload the entire page again. The various interactive functions, such as discussions, shouts, polls and blogs, may be bundled as sets and mapped to certain unique identifiers, such as unique URLs, geocodes, UPC, ISBNs, etc. The bundle organization may be networked, or potentially form a containment hierarchy. By mapping to unique identifiers, the bundles of sets of functionality may create communities centered around a certain topic or book, or may create geographically centered communities.

### CROSS-REFERENCE

This application is a continuation-in-part application of Ser. No. 12/060,087, filed Mar. 31, 2008, which is incorporated herein by reference in its entirety and to which application we claim priority under 35 USC §120. This application also claims the benefit of U.S. Provisional Application No. 61/095,600, filed Sep. 9, 2008, which application is incorporated herein by reference in its entirety.

### FIELD OF INVENTION

The invention relates to facilitating interactive functions for an online community. More particularly, the invention relates to methods for bundling disparate sets of web resources to unique string identifiers.

### BACKGROUND

The Internet is a worldwide network of interconnected networks, which includes both public and private local and wide area networks of computers. Online communities, hosted over the Internet, are continuously growing in popularity. Today's Internet users may belong to several of a growing number of online communities, to meet other internet users, share ideas and comments, and communicate via both public message boards and private messaging. Online users build relationships with other users over the Internet through common interests, goals or concerns. In addition, online users may be brought together based on similar interests in popular issues or activities.

Today's online communities, however, are often limiting because users must access the online community's web pages and databases in order to participate in such communications among community members, post to message boards, or send other users messages. An Internet user currently has no means of participating in online community discussions while navigating the web in an Internet browser, without visiting an online community's website to participate in such discussions.

Further, service providers, interest groups, and those who are not members of such online communities cannot benefit from the information processes or communication among members that are within the community. For example, a television show's owner or production company currently cannot benefit from and has no access to any discussions regarding the television show that occur within any given online community, without becoming a member of that community.

What is needed is an effective tool and way to aggregate information and functionalities from web pages of the Internet and online community.

### SUMMARY OF INVENTION

The invention provides methods for bundling disparate sets of web resources to unique string identifiers. Various aspects of the invention described herein may be applied to any of the particular applications set forth below. The invention may be applied as a standalone method for bundling or as a component of an integrated software solution to facilitate interactive functions of an online community. The invention can be optionally integrated into existing web pages seamlessly. It shall be understood that different aspects of the invention can be appreciated individually, collectively or in combination with each other.

In one embodiment of the invention, a method for facilitating interactive functions for an online community comprises the following steps: downloading a web page of a website into a browser, mapping bundles of sets of interactive functions to a unique string identifier, associating the unique string identifier with the web page where the unique string identifier corresponds to the bundles of sets of interactive functions, and displaying a semi-transparent or translucent interactive region in the browser having links to the interactive functions for interacting with members of the online community.

Unless specifically stated otherwise, as apparent from the following discussions, it is appreciated that throughout the specification, discussions utilizing terms such as “processing,” “computing,” “calculating,” “determining,” or the like, may refer in whole or in part to the action and/or processes of a processor, computer or computing system, or similar electronic computing device, that manipulate and/or transform data represented as physical, such as electronic, quantities within the system's registers and/or memories into other data similarly represented as physical quantities within the system's memories, registers or other such information storage, transmission or display devices. It will also be appreciated by persons skilled in the art that the term “users” referred to herein can be individuals as well as corporations and other legal entities. Furthermore, the processes presented herein are not inherently related to any particular computer, processing device, article or other apparatus. An example of a structure for a variety of these systems will appear from the description below. In addition, embodiments of the present invention are not described with reference to any particular processor, programming language, machine code, etc. It will be appreciated that a variety of programming languages, machine codes, etc. may be used to implement the teachings of the invention as described herein.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

Some of the features of the invention are described as set forth in the following figures and description. A better understanding of the features and advantages of the invention will be obtained by reference to the following detailed description that sets forth illustrative embodiments provided in accordance with the invention.

FIG. 1 shows a web page with the semi-transparent interactive community tool for an online community.

FIG. 2 shows an example of links to interactive functions from the semi-transparent region.

FIG. 3 shows an example of one way a user can contribute to an online community through an interactive function from the semi-transparent interactive application.

FIG. 4 shows an example of a blog that is published within the semi-transparent region.

FIG. 5 shows an example of a web page interacting directly with a database that stores and a server that manages content of an online community submitted by the semi-transparent interactive application (community tool).

FIG. 6 shows an example of a system for displaying a semi-transparent interactive application on a web page for facilitating interactive functions of an online community.

FIG. 7 shows a method for displaying a semi-transparent interactive application on a web page.

FIG. 8 shows an example of a mapping of sets of functionality to sets of unique string identifiers.

FIG. 9 shows an example of a method for bundling sets of functionality.

### DETAILED DESCRIPTION OF INVENTION

In the following detailed description, numerous specific details are set forth in order to provide a thorough understanding of the invention. However it will be understood by those of ordinary skill in the art that the invention may be practiced without these specific details. In other instances, well-known methods, procedures, components and circuits have not been described in detail so as not to obscure the invention. Various modifications to the described embodiments will be apparent to those with skill in the art, and the general principles defined herein may be applied to other embodiments. The invention is not intended to be limited to the particular embodiments shown and described.

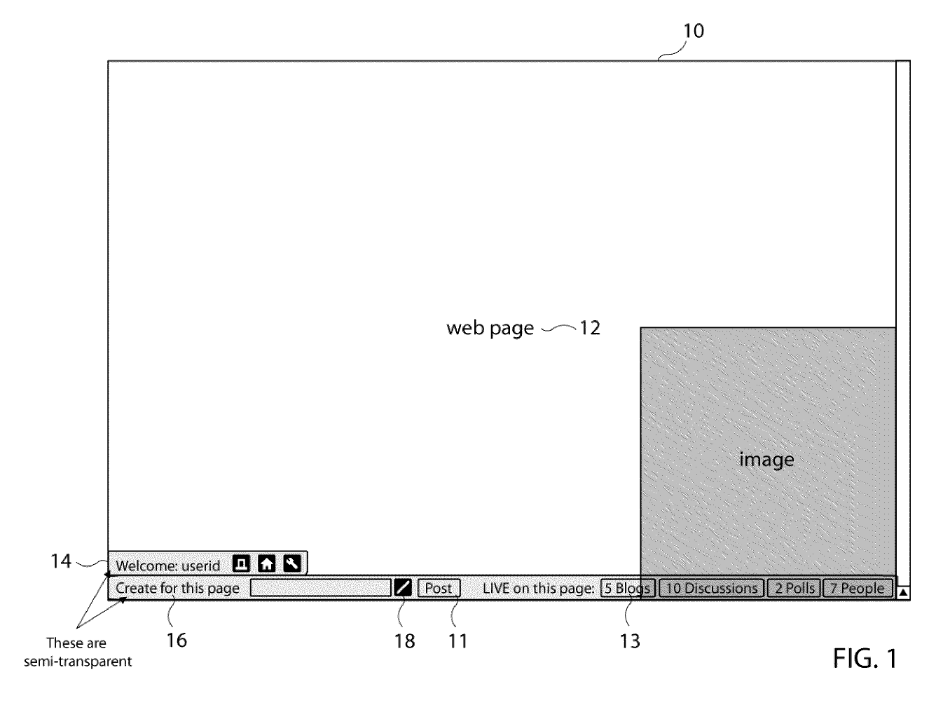

An aspect of the invention provides a user interface for facilitating interactive functions for an online community. Referring to FIG. 1, the user interface may include a web page 12 displayed in a browser 10. Additionally, a semi-transparent (or translucent) interactive region 16 may be loaded into the browser. The semi-transparent (or translucent) interactive application 16 may include a welcome bar 14, as well as additional links to various interactive functions 13 contextual to the web page 12 where members of an online community can upload content to the online community. In one embodiment, for example, if the web page 12 is a web page for a television show, then the links to interactive functions 13 may include links where a user can interactively blog, chat, or participate in discussions. Such links may be accessible through the interactive application. The links to various interactive functions 13 are thus contextual to the web page 12.

As illustrated in FIG. 1, the semi-transparent (or translucent) interactive display “bar” 16 does not block the viewing of the web page, and is not loaded as a new tab or in a new browser window, and does not use links directing the user to separate web pages. Rather, the community tool 16 is semi-transparent (or translucent), without blocking the underlying web page 12. In this way, the present invention provides a graphical user interface in which the semi-transparent (or translucent) interactive display “bar” 16 can increase the viewable area of a display screen for user information. More specifically, the present invention utilizes semi-transparent displays that allow the visualization of user information therethrough. This effectively increases the usable area of the display screen. The present invention is therefore particularly advantageous for small screen applications.

The semi-transparent interactive region allows graphic images, including text images, of the document to be viewed therethrough. By allowing this advantageous feature, the effective viewable (e.g., usable) area of the display screen is increased to include those areas that coincide with the semi-transparent interactive application user interface. Currently, applications that are not transparent nor semi-transparent require their own display area. Therefore, online community forums implemented without the benefits of the invention require a separate display area. That is to say, there is a “window area” in which document information or web page information is displayed and a separate, different area, where information pertaining to an online community, forums, discussion boards, blogs, etc. can be displayed. Thus, in current applications, a user effectively must view a web page in one window or browser tab and participate in an online community in an entirely different window or browser tab.

In accordance with the present invention, the interactive display application is semi-transparent (or translucent) thereby allowing information of the document to be viewed therethrough. This effectively allows the application to be incorporated or merged directly with the window area and a separate area for viewing content from and participating in an online community is avoided.

In one embodiment of the invention, a computer-implemented user interface may provide a semi-transparent interactive application that displays a semi-transparent interactive community tool for increased screen usage. The present invention includes a user interface having a semi-transparent interactive region (“bar”) displayed within a display window area of a computer screen. The region (“bar”) is semi-transparent in that it allows the visualization of text and/or other graphical information that coincides in screen location with the semi-transparent application (e.g., “behind information”). By allowing the visualization of “behind information,” the present invention effectively increases the display screen's usable space for displaying information to a user.

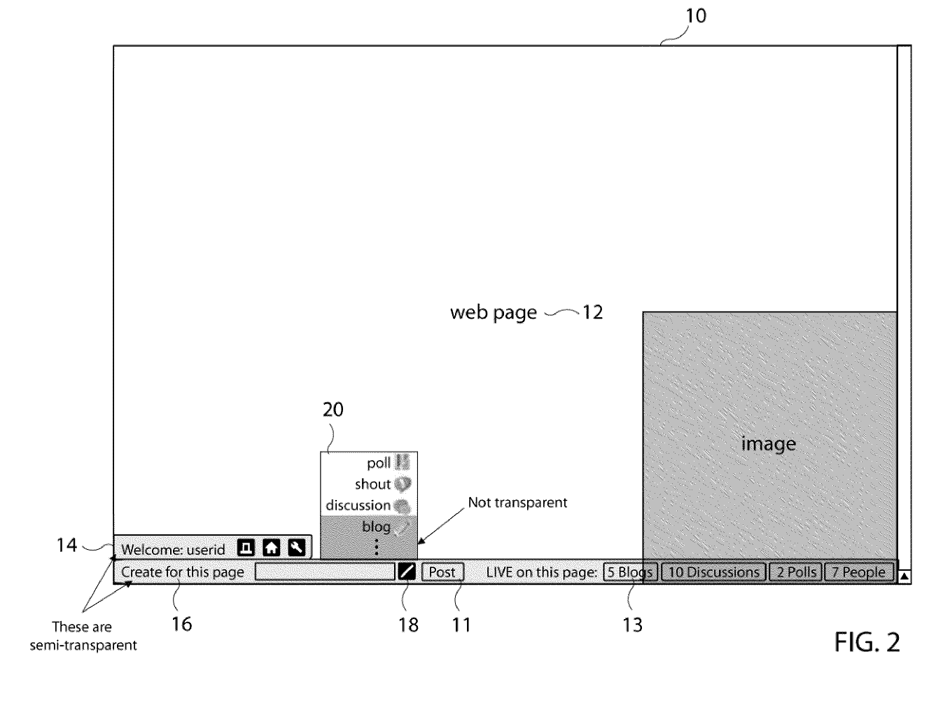

Referring to FIG. 2, in another embodiment of the invention, the semi-transparent interactive application may contain links to interactive functions through menu options 20. In one embodiment, the menu options 20 may not open as a pop-up that blocks the viewing of the web page, or as a new tab or browser window, rather the menu options 20 open as a semi-transparent menu 20, published seamlessly without reloading the web page, and without blocking the underlying web page 12. The menu options 20 may contain links to interactive functions that are contextual to the web page. For example, in one embodiment, if the web page 12 is a web page for a television show, then the links to interactive functions may include links where a user can interactively blog, chat, or participate in discussions. In another example, if the web page 12 is a web page for a product or an online store, then the links to interactive functions may include links where a user can submit product reviews or ratings. It will be appreciated by those skilled in the art that the invention is not be limited to the interactive functions and web pages as described herein, and may be applied to a wide variety of web pages and interactive functions.

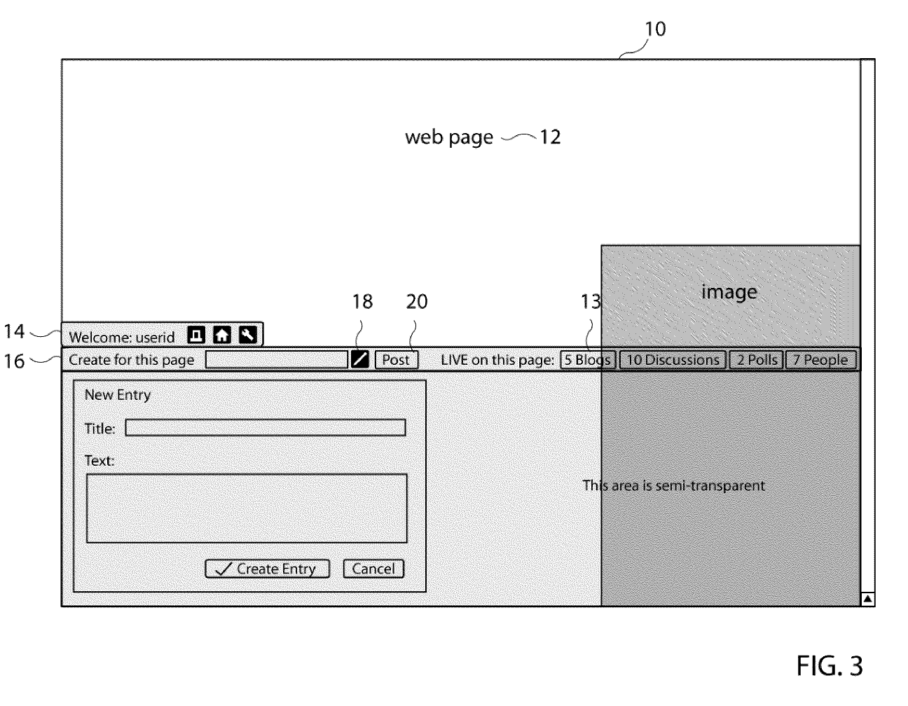

In one embodiment of the invention, and referring to FIG. 3, if a user selects an interactive function, a new session may be published seamlessly without having to reload the entire web page again. For example, in one embodiment, if a user wants to contribute a new blog entry to an online community, the user may select the option from a menu of options for various interactive functions, and then a new blog session 30 may be published seamlessly in the semi-transparent region. For practical reasons, if a user is entering text or contributing text to an online community, the new blog session 30 may be a non-transparent region of the semi-transparent interactive application. To avoid blocking other sections of the underlying web page, the other inactive areas of the interactive application may remain semi-transparent. A user may submit an entry through a “Create Entry” link 32 or “Cancel” 34. It will be appreciated by those skilled in the art that the invention is not limited to publishing blogs, but can be applied to submitting or contributing any kind of content to an online community that may be contextual to the web page. For example, a user may submit text as part of an online discussion regarding content on the web page, or responses to polls about topics raised by the web page, or product ratings or reviews to products on the web page, or a variety of additional content.

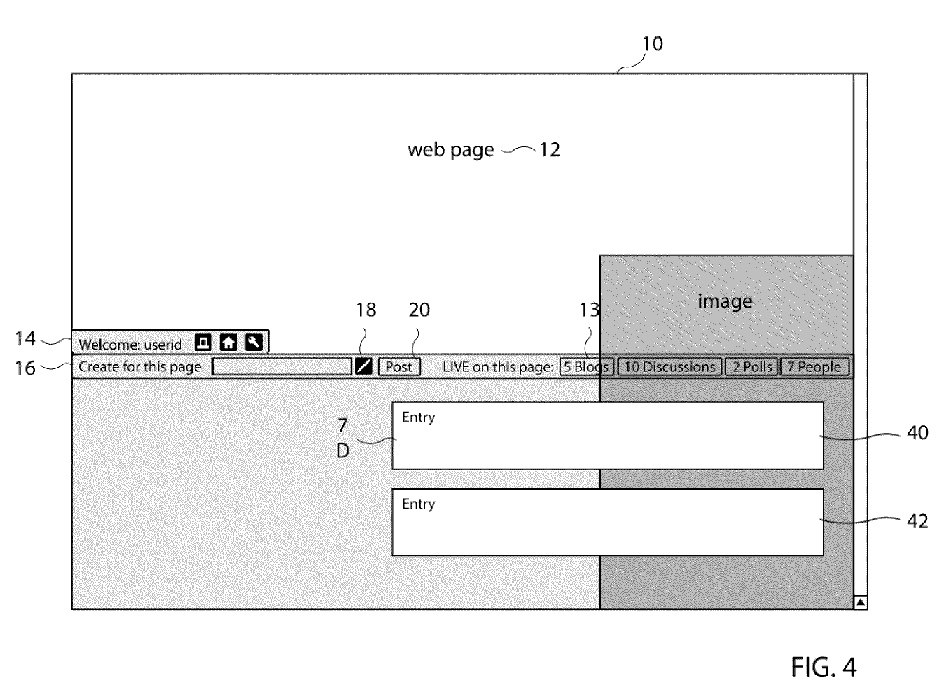

Referring to FIG. 4, after a user submits content to the online community, his entry may be displayed within the semi-transparent interactive community tool 42. In one embodiment, other contributions to the community may also be displayed in the semi-transparent interactive region 42. Further, in some embodiments of the invention, a user can access content of the online community through various links to interactive functions 13. For example, a user who would like to see blogs contextual to the current web page may click on a link to blogs 13 and see blog entries 40 displayed within the application. The active area where text is displayed 42, for practical reasons, may be nontransparent to better facilitate a reader's ability to read the text, while other inactive areas of the application may remain semi-transparent to avoid blocking a user's view of the web page 12.

Within the present invention, the interactive display “bar” (region) is semi-transparent and allows images associated with the document and underlying web page to be viewed therethrough. Thus, the text images from the underlying web page can be clearly seen through the interactive display “bar” (region). There are a number of different mechanisms that can be used to display the semi-transparent interactive display “bar” (region) and in accordance with the present invention. Exemplary methods are described herein. In one embodiment, the semi-transparent interactive display “bar” is displayed in a light color scheme rasterized such that graphic images of the open document can be viewed therethrough. Although a variety of different mechanisms can be used to generate a semi-transparent graphic image, one method of generating a semi-transparent graphic object is described in U.S. Pat. No. 5,283,560 issued on Feb. 1, 1994 to Bartlett, which is incorporated herein by reference. In another embodiment, the semi-transparent interactive “bar” (region) is displayed in outline form where the graphic image is only its outline. The outline and inner portions of the semi-transparent interactive display “bar” (region) are semi-transparent.

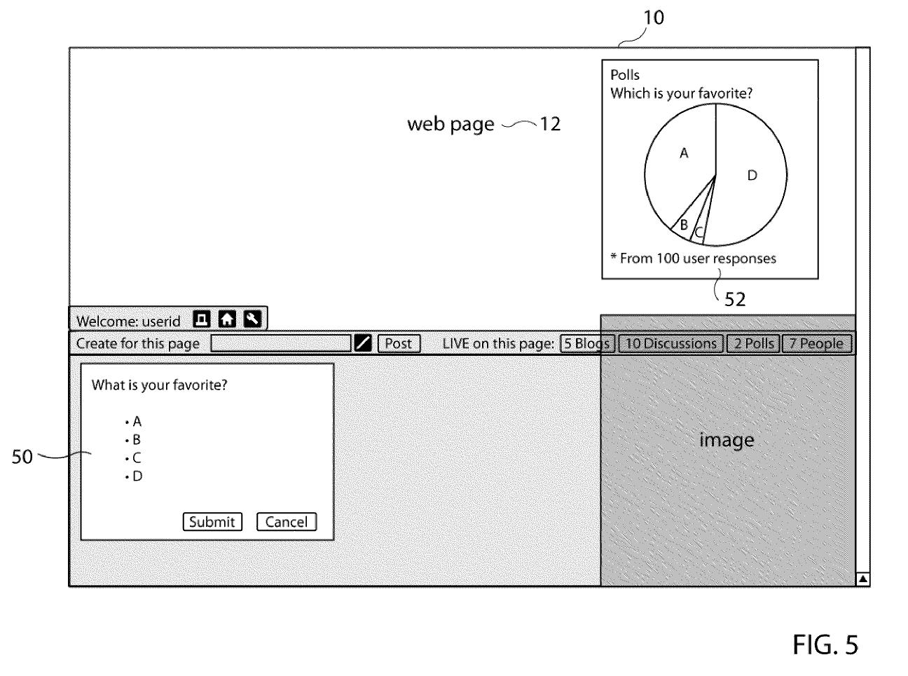

Although the scope of the invention is not limited in this respect, embodiments of the invention may have the web pages interacting directly with the database that stores the information of the online community. Information for an online community that is contextual to a web page may be contributed through the semi-transparent interactive application (community tool), and the web page may interact directly with the database that stores that information and the server that manages that information in order to update the web page itself For example, referring to FIG. 5, the semi-transparent interactive application may solicit information from members of an online community to participate in polls, discussions, etc. via links to interactive functions or sessions loaded into the semi-transparent interactive application 50. In one embodiment, the semi-transparent interactive application may solicit information via a poll or shout. When the user submits their response to the poll, or alternatively submits content to the online community, the application may store the information in a database managed by a server. The web page may communicate directly with the database and server in order to update the content on the underlying web page 12.

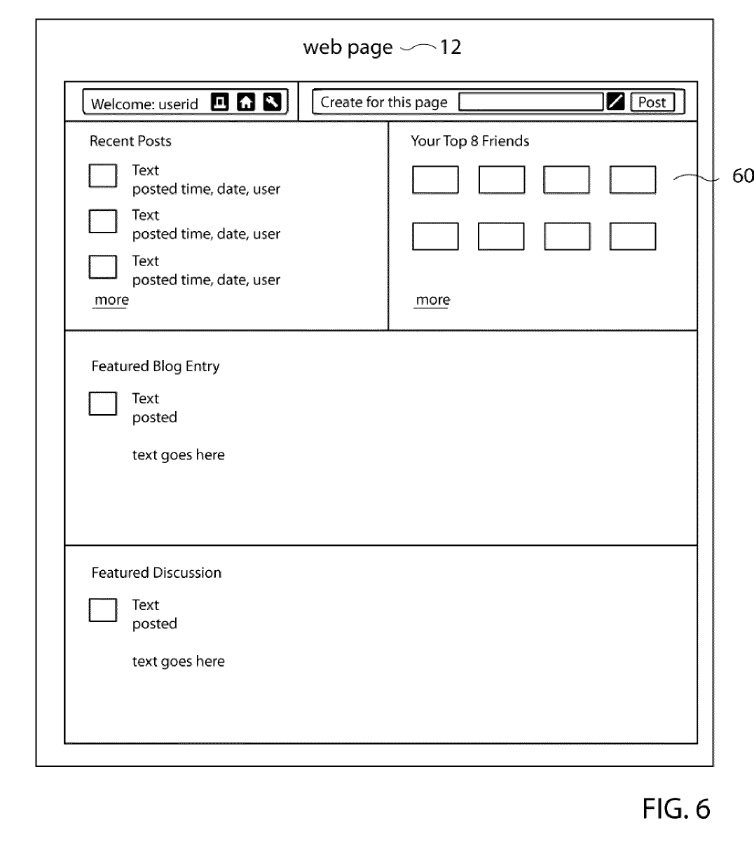

Referring to FIG. 6, embodiments of the invention may provide for functions within the interactive application that allow a user to view content submitted to the online community and stored in a database managed by a server. Further, a user may view content submitted by other users within the online community with whom they have relationships. For example, in one embodiment, a user may have relationships to other members of the community, and those relationships may be displayed by the interactive application. To illustrate, in FIG. 6, a user's top eight “friends” are displayed within the interactive application.

In various embodiments of the invention, the user may view, within the semi-transparent region, a variety of content within the online community, including a user's own recent submissions, or for example, blog postings or even other user's submissions, for example, blog postings or discussions. Further, a user's view may be limited within the application to only submissions by users with whom they have relationships or connections, or even by users with whom the degree of separation is less than a specified number, i.e., only submissions from users within two degrees of separation. In addition, it is possible to rank the order that such content is displayed, for example, displaying blogs by popularity or sorted by date created. One skilled in the art can appreciate that the invention is not limited to the examples described herein, and a wide variety of content can be viewed within the application in a variety of ways.

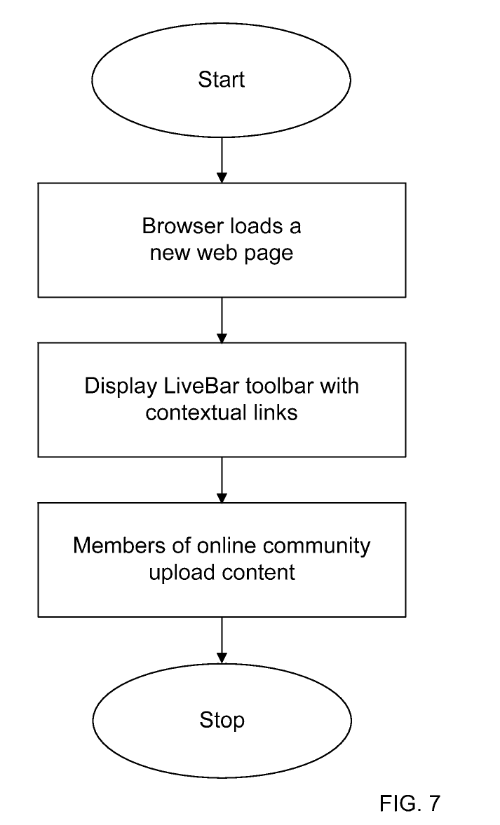

One aspect of the invention provides a method, as shown in FIG. 7, for facilitating interactive functions for an online community, comprising steps of downloading a web page of a website into a browser and displaying a semi-transparent region in the browser having links to interactive functions contextual to the web page, where members of the online community may upload content to the online community. Within this method, in one embodiment, the interactive application (community tool) may display both active and inactive areas. For example, if a member of an online community selects an interactive application, e.g., to create a new blog, then an active area of the application may load, in order to enable the user to upload content to the community, e.g., to enter text to create the blog. The interactive link does not open a new web page, pop up, or tab in a browser window, rather it is published seamlessly within the application, without having to reload the page. For practical reasons, in order to better read and display the text that the user is entering in, it may be possible to make the active area of the blog nontransparent, while the rest of the application remains semi-transparent without blocking the view of the web page. When the user is done entering text or exits the active area, then the active area will no longer need to be nontransparent, and can close, and the application will no longer need a nontransparent region. Similarly, the same may occur while a user is not submitting information to the community, but rather is viewing information and displaying content from the online community. It is possible, then, to have both active areas and inactive areas of the semitransparent interactive application, where the active area is nontransparent when one of the members of the online community selects the active area to upload content to the online community or display content uploaded to the online community, and additionally, inactive areas of the semi-transparent interactive bar that remain semi-transparent throughout use of the application.

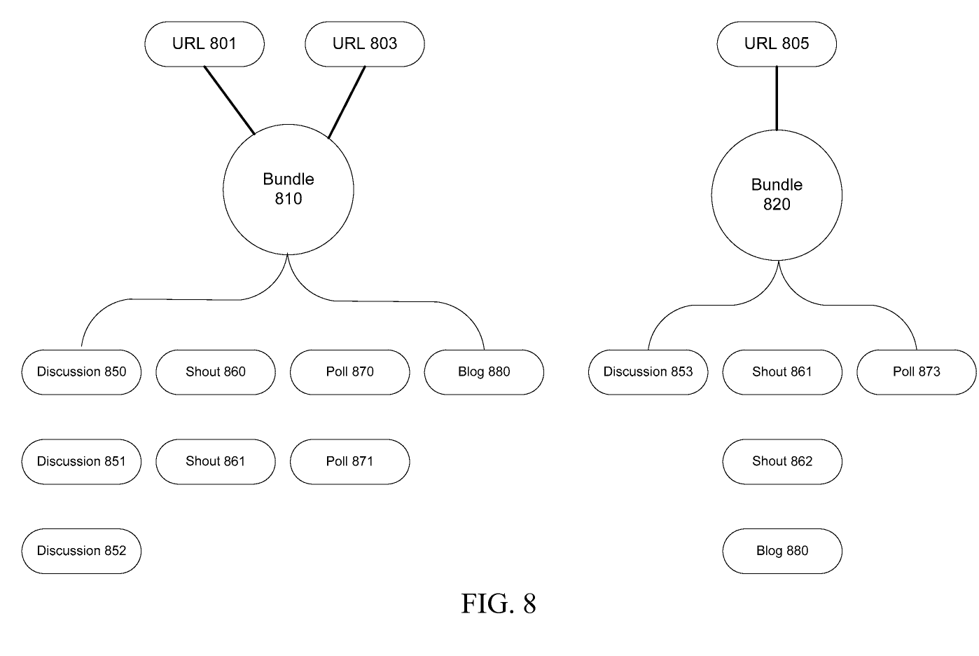

Referring to FIG. 8, in implementing the user interface, one aspect of the invention may provide for a method of bundling that allows the ability for the user interface or semi-transparent interactive display “bar” to map sets of functionality to sets of unique string identifiers. Sets of functionality may be sets of web resources or information such as discussions, shouts, polls, or blogs. For example, one set of functionality may be a particular discussion about a certain topic. Another set of functionality may be blogs about a certain topic. These sets of functionality may be mapped to sets of unique string identifiers, for example, a set of client URLs.

A user or entity may set up a bundle to display certain discussions across multiple pages of their site that implement the semi-transparent interactive bar. For example, if a website has a set of pages relating to a certain television show, then a bundle with sets of functionality or community resources relating to that television show may be mapped to a certain URL or sets of URLs. In this way, discussions, shouts, polls and blogs pertaining to the televisions show may be bundled together so that they are displayed across all pages of a certain site via the semi-transparent interactive display “bar”.

When loading the semi-interactive display “bar”, a default bundle of discussions, shouts, polls, blogs or other kinds of interactive functions may first be loaded. In addition, a website administrator or other user may be able to create a custom bundle of interactive functions that can be accessed via the semi-transparent interactive display “bar”. Thus, for example, URL 801 and URL 803 may both provide access to discussions 850, 851, and 852, shouts 860, 861, polls 870, 871, and blog 880, even if these resources or discussions, shouts, polls, and blogs are on separate servers. If a user moves to URL 805, they may have access to discussion 853, shouts 861, 862, poll 873, and blog 880 via the semi-transparent interactive display bar. The semi-transparent interactive display bar stays constant on the user's screen as the user moves from URL 801 to 803 to 805, however the particular interactive functions (or community resources) such as discussions, shouts, polls, or blogs will vary depending on the bundles that are mapped to it. Each unique string identifier may be linked to at least one bundle. A bundle may have certain defining characteristics as well such as a name or ID number.

The unique string identifiers may be particular URLs, and thus the bundles may be associated with particular web pages or domain names. In addition, the string identifiers may be geocodes, and thus the bundles may be geographically oriented, and thus create geographically centered communities via the semi-transparent interactive display. The unique string identifier may also use the geographic code that is automatically generated from a device, for example, a mobile device. Alternatively, the unique string identifiers may be ISBNs and thus bundle interactive functions or community resources for certain books and create communities around books. One skilled in the art can appreciate that the unique identifiers may be any type of well-defined identifiers that provide context and separation, including URLs, geocodes, UPC, ISBNs, etc., but are not limited to the identifiers that are described herein.

Further, as shown in FIG. 8, different interactive functions residing on different servers may be part of multiple bundles. For example, shout 861 and blog 880 may be mapped to both bundle 810 and bundle 820. Thus, the bundle organization is networked rather than hierarchical. Further, the bundle organization may also be nested by using the unique string identifiers. Thus, for example, if one string is contained in another string, then the bundle associated with that string will also be contained in the other bundle, thus forming a containment hierarchy. As an example, if one bundle is named “www.liveworld.com” and another bundle is named “www.liveworld.com/products”, then the bundle associated with www.liveworld.com may also be contained in the bundle associated with www.liveworld.com/products.

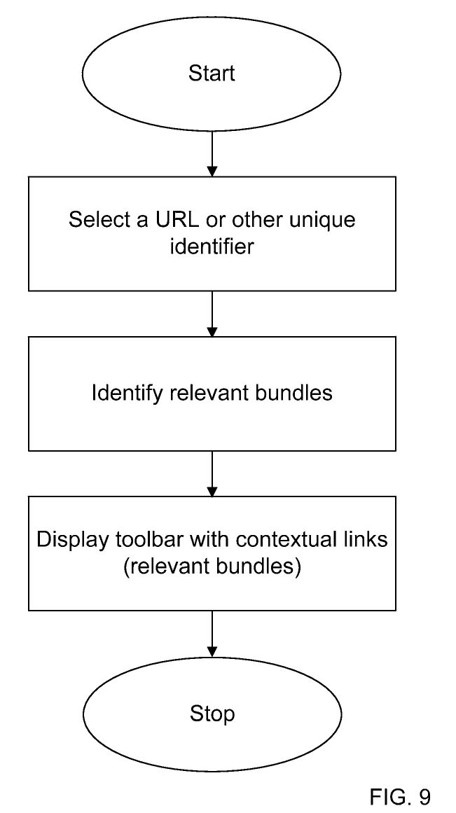

Referring to FIG. 9, a flowchart may show that the unique identifier or URL is first selected, and a new web page may be loaded into a browser window. Then, relevant bundles that are linked to the unique identifier or URL are identified. These bundles will determine the content that is displayed in the interactive toolbar, as well as which contextual links are displayed for the users to interact with.

All concepts of the invention may incorporate and integrate current applications of encoding of geographical location information, including but not limited to those described in U.S. Patent Pub. No. 2007/0016651 A1 (Blagsvedt et al.) published on Jan. 18, 2007, which is hereby incorporated by reference in its entirety.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A method for facilitating interactive functions for an online community, the method comprising the following steps:
downloading a web page of a website into a browser;
mapping bundles of sets of interactive functions to a unique string identifier;
associating the unique string identifier with the web page, where the unique string identifier corresponds to the bundles of sets of interactive functions; and
displaying a semi-transparent interactive region in the browser having links to the interactive functions for interacting with members of the online community.

2. The method of claim 1, wherein the interactive functions include discussions, shouts, polls or blogs.

3. The method of claim 1, wherein the unique string identifier is a URL, geocode, barcode, UPC or ISBN.

4. The method of claim 1, wherein the unique string identifier is a geographic code automatically generated from a mobile device.

5. The method of claim 1, wherein the online community is centered around a topic.

6. The method of claim 1, wherein the unique string identifier is an ISBN and the online community is centered around a book.

7. The method of claim 1, wherein the unique string identifier is a geographic code and the online community is centered around a location.

8. A method for facilitating interactive functions for an online community, the method comprising the following steps:
downloading a web page of a website into a browser;
mapping a first bundle of sets of interactive functions to a first unique string identifier;
mapping a second bundle of sets of interactive functions to a second unique string identifier;
associating each unique string identifier with the web page, where the unique string identifiers correspond to the bundles of sets of interactive functions; and
displaying a semi-transparent interactive region in the browser having links to the interactive functions for interacting with members of the online community;
wherein the first unique string identifier is contained within the second unique string identifier, and the first bundle of sets of interactive functions is also contained in the second bundle of sets of interactive functions, forming a containment hierarchy.

9. A user interface for facilitating interactive functions for an online community comprising:
a web page displayed in a browser; and
a semi-transparent interactive application in the browser having links to a set of interactive functions contextual to the web page, where members of the online community can upload content to the online community;
wherein the set of interactive functions corresponds to a unique string identifier associated with the web page.

10. The user interface of claim 9 wherein the unique string identifier is a URL of the web page.
